(19) United States
(12) Patent Application Publication
(10) Pub. No.: US 2006/0131084 A1
(43) Pub. Date: Jun. 22, 2006

(54) Motorized handle

(76) Inventor: Fred Rupp, Littleton, CO (US)

Correspondence Address: LATHROP & GAGE LC, 4845 PEARL EAST CIRCLE, SUITE 300, BOULDER, CO, 80301, US

(21) Appl. No.: 11/315,845

(22) Filed: Dec. 22, 2005

Related U.S. Application Data
(60) Provisional application No. 60/639,957, filed on Dec. 22, 2004.

(51) Int. Cl. B60K 1/00

(52) U.S. Cl. 180/65.1; 280/87.042

(57) ABSTRACT

A motorized handle includes an elongate handle to which is attached a wheel and a motor to drive the wheel. A rider mounting a rolled conveyance, such as a skateboard or a pair of roller blades, may use the motorized handle to impart propulsion.

### RELATED APPLICATIONS

This application claims benefit of priority to U.S. provisional application Ser. No. 60/639,957 filed on Dec. 22, 2004.

### BACKGROUND

1. Field of the Invention

The invention pertains to self propelled devices, such as skateboards and the like, which are provided with a motor for self propulsion.

2. Description of the Related Art

Traditional skateboards, roller blades and roller skates operate on the principle of gravity to provide acceleration for a rider. Reliance upon gravity for motive force is problematic in that a rider may only ride downhill. For example, a skateboard must either be carried uphill to repeat the process or, if the surface is relatively flat, driven in a way that is quite awkward—the rider scoots along with one foot on the skateboard and the other foot contacting the ground in a quasi-walking mode. Absence of motorized propulsion precludes a wider range of use.

Attempts have been made to install operative motors on skateboards, but these suffer from a variety of problems. It is problematic that the overall apparatus is relatively small, there is a need to temporarily disengage the motor from the drive assembly without a complicated transmission to perform this function, and the overall assembly must be steered in the manner of a traditional skateboard. By way of example, U.S. Pat. No. 5,381,870 issued to Kaufman shows a drive motor directed through a drive belt to a rear driven sprocket. U.S. Pat. No. 5,839,737 issued to Kruczek shows a motorized skateboard having a transmission that is actuated by the rider shifting weight on a fulcrum-lever, but this type of arrangement interferes with the rider's balance and may lead to loss of control.

There remains a need to provide an improved motorized skateboard where the motor may be selectively engaged to drive the wheels.

### SUMMARY

The present instrumentalities overcome the problems outlined above and advance the art by providing a motorized handle that has a selectively engageable drive mechanism. This advantageously permits a rider to grasp the motorized handle and impart propulsion to a rolled conveyance.

The motorized handle may include an elongate handle presenting an upper end and a lower end. A wheel is attached to the handle proximate to the lower end. A motor is attached to the handle proximate the wheel. A drive mechanism extends between the motor and the wheel, such that the drive mechanism configured to impart motive force to the wheel.

By way of example, the motor may be an air cooled gasoline engine that is equipped with a centrifugal clutch. The centrifugal clutch may drive a shaft that resides in frictional contact with the wheel. A clamp assembly may be used to adjust the strength of the frictional contact between the shaft and the wheel. The handle may be an extensible handle that is formed in at least two telescoping segments and retained in a fixed length by a clamp.

A method for a rider to propel a rolled conveyance includes the rider mounting the rolled conveyance. The rider grips the motorized handle and places the wheel on the ground for application of motive force. The motive force is imparted to the rolled conveyance through the rider's body and is used to propel the rolled conveyance. The rider may use the motive force as an aid to steering, an aid to travel, and an aid to balance.

The rolled conveyance may be, for example, a skateboard, a pair of roller blades or roller skates, a bicycle, a scooter or a wheelchair

### BRIEF DESCRIPTION OF THE DRAWINGS

FIG. 1 shows a rider who is using a motorize handle to propel a skateboard;

FIG. 2 is a front elevational view of the motorized handle and provides additional detail with respect to FIG. 1;

FIG. 3 is a left side elevation view of the motorized handle and provides additional detail with respect to FIG. 1.; and

FIG. 4 is a front view of the rider using the motorized handle.

### DETAILED DESCRIPTION

The present teaching is by way of example to illustrate the preferred embodiments.

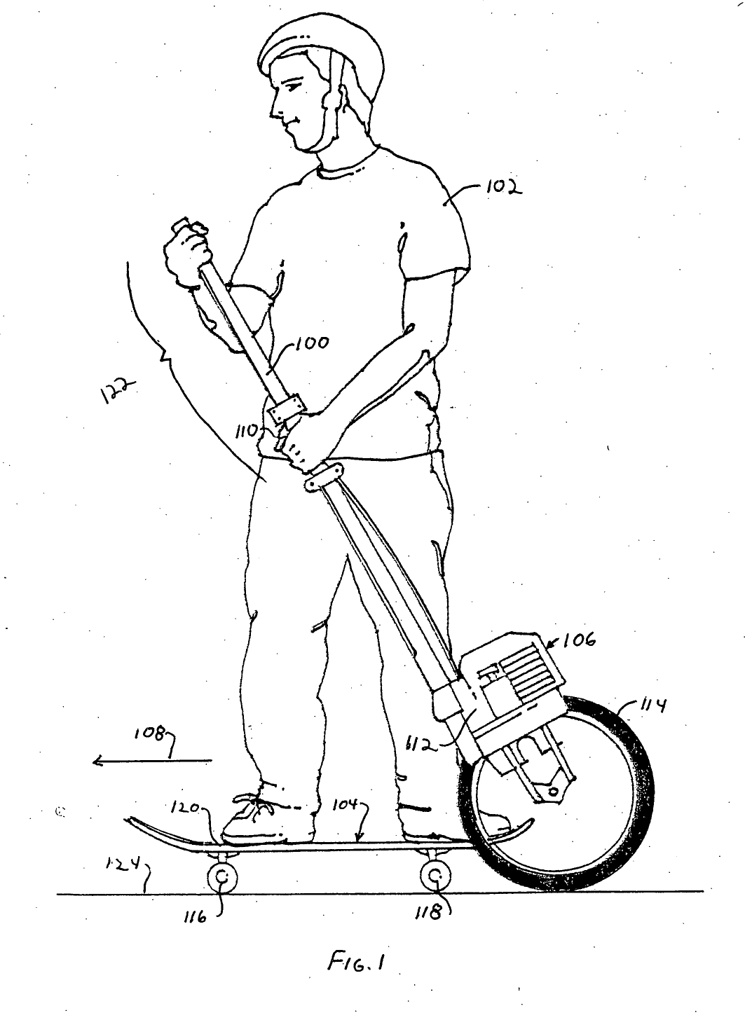

FIG. 1 shows a motorized handle 100 that permits a rider 102 to propel a conventional skateboard 104. The motorized handle contains a selectively engageable drive mechanism 106. The selectively engageable drive mechanism 106 is operable in two modes, namely, a coasting mode and a drive mode that the rider 102 may use to propel the skateboard 104 forward in the direction of arrow 108. The rider 102 is able to engage the selectively engageable drive mechanism 104 and enter drive mode, for example, by depressing a throttle lever 110 that causes engine 112 to accelerate. The engine 112 is equipped with a centrifugal clutch (not shown) that causes the engine 112 to impart motive force for revolution of wheel 114.

The skateboard 104 is of conventional design, for example, having two sets of wheels 116, 118 connected to board body 120. The motorized handle 100 is preferably not connected by a mechanical linkage to the motorized handle 100, although it is also contemplated that a direct mechanical linkage of this type may be provided. Thus, the rider 102 may grip the handle section 122 as shown as an aid to drive, steering and balance against the ground 124. The rider 102 may move or reposition the motorized handle 100 to a variety of positions including positions that are forward, rearward, laterally to the left and/or laterally to the right compared to what is shown in FIG. 1. The motorized handle 100 is placed in a coast mode by releasing the throttle lever 110 to disengage the centrifugal clutch.

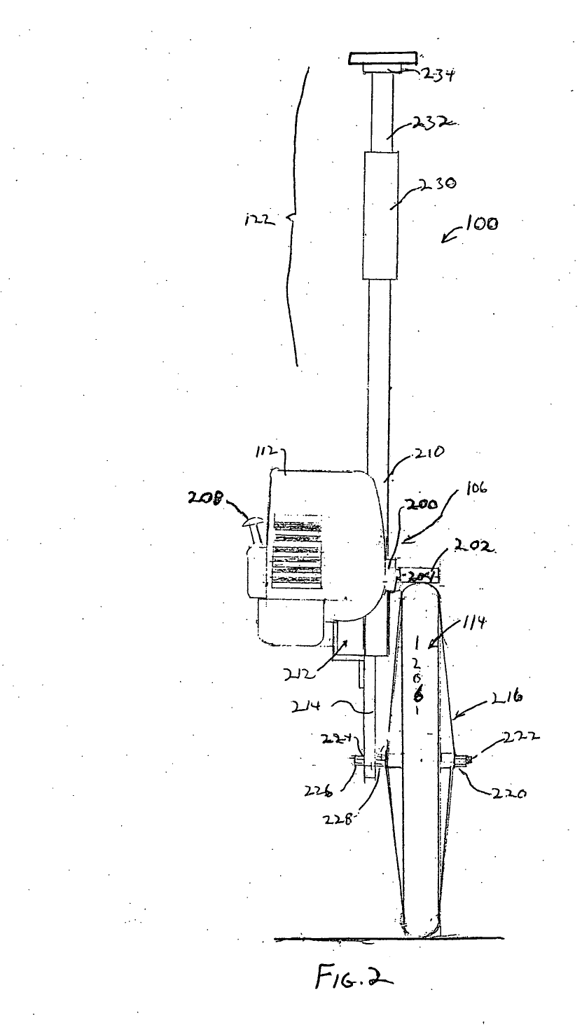

FIG. 2 shows the motorized handle in front elevational view and provides additional detail with respect to FIG. 1. Motor 112 is suitably, for example, an air-cooled two cycle internal combustion engine having 21 cubic centimeters of displacement and equipped with a centrifugal clutch. Motors of this type may be found, for example, on conventional hand held motorized grass trimming apparatus, such as equipment sold by Toro or Lawnboy. The centrifugal clutch, which is shown generally as 200, operates on the principle of centrifugal expansion of a spring-biased radial member (not shown) to engage internal structures for drive actuation of shaft 108. The centrifugal expansion occurs sufficiently for this purpose when the engine 112 is accelerating past a design threshold for drive engagement. An engine of this type that is equipped with a centrifugal clutch is, by way of example, shown and described in U.S. Pat. No. 6,773,375 issued to Nagashima, which use incorporated by reference to the same extent as though fully disclosed herein. The centrifugal clutch mechanism selectively engages a shaft 202 depending upon the speed of rotation in engine 112. It is also possible to use, for example, other types of motors, such as battery powered motors that are used on lawn trimming apparatus. In the case of electric motors, which are advantageously quieter but may have short service lives between charges, the speed of rotation may be electronically controlled and a centrifugal clutch is not needed.

The shaft 202 presents an outer surface 204, which is in direct contact with radially outboard surface 206 of wheel 114. Motive force from the shaft 202 transfers to wheel 114 by frictional engagement between the respective surfaces 204, 206, commensurate with rotation of shaft 202 to drive wheel 114. The motor 112 may be cranked by hand crank cord 208 and selectively accelerated by actuation of throttle 110 (not shown). Accordingly, the rider 102 selectively uses the speed of rotation in motor 112 to place the motorized handle in coast mode or drive mode by the actuation of throttle lever 110 and, indirectly, the centrifugal clutch 200 to impart motive force to the wheel 114 through shaft 108.

Motor 112 mounts to lower handle section 210 by the provision of adapter clamp assembly 212, which couples the motor 112 and lower handle section 210 with a wheel segment 214. The precise construction of clamp assembly 212 is unimportant, so long as the clamp assembly 214 conformably adapts, for example, to the motor 112 for attachment to lower segment 210 and/or the wheel segment 214. Wheel 114 is connected by spokes 216 to a central hub 220. An axle 222 connects the hub 220 to the wheel segment 214 by extension through aperture 224 and is retained by nuts 226, 228.

The lower segment 210 is tubular and rises towards an extension clamp 230. Top member 232 is telescoping received within the lower segment 210. Adjustment of the clamp assembly 230 permits extension and de-extension of the handle section 122 by axial sliding motion of top member 232 relative to the lower segment 210. The top member 232 is optionally provided with a grip 234 to assist the rider 102 in using the motorized handle 100.

The shaft 202 and wheel 114 have different outer circumferences at surfaces 204, 206. A drive ratio is defined as the ratio of these circumferences. The drive ratio may vary as a matter of design choice, but should not be so low that the motor 112 stalls when in drive mode or so high as to propel a rider uncomfortably fast. The drive ratio should not be so low that the maximum speed is boring to the rider. A drive ratio of about 30:1 (wheel 114 to shaft 202) is most preferred in the class of low power gasoline engines. In practice, this ratio has been found to strike a good balance between these design criteria for a 21 cubic centimeter motor 112 when drive wheel 114 has a sixteen inch diameter. The drive ratio may suitably vary in a preferred range from 10:1 to 30:1 for teenagers and adults, and from 10:1 to 20:1 for younger people.

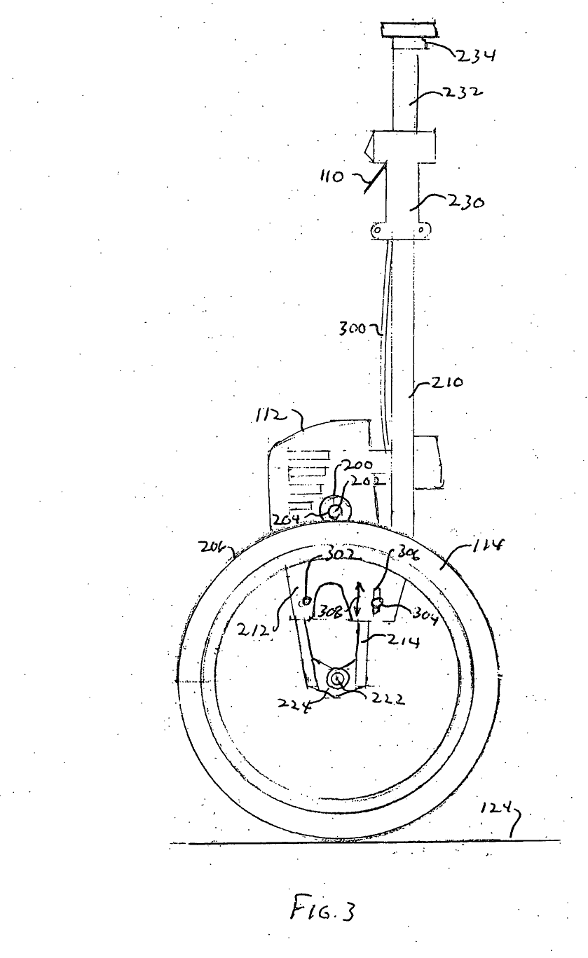

FIG. 3 is a left side elevational view of the motorized handle 100 and provides additional detail with respect to FIG. 1. The throttle lever 110 is coupled with a Bowden cable 300 for throttle control of motor 112. The clamp assembly 212 is coupled with wheel segment 214 by a pivot 302 and a bolt 304. The bolt 304 ride over a slot 306 and may be untightened for sliding 308 of the wheel segment 214 relative to the clamp assembly 212 with commensurate pivoting motion around pivot 302. This pivoting motion, as translated to motor 122 through clamp assembly 212, brings surface 204 into contact with surface 206 with sufficient strength for frictional drive according to the principles discussed above.

In operation, the rider 102 starts the motor 112 and grips the handle section 122. The rider is shown in FIG. 1 as standing on a skateboard 104, but there may also be used roller skates, roller blades, scooters, or other such rolling devices as wheelchairs. The rider 102 actuates throttle lever 110 to enter drive mode or coast mode, according to the rider preference. The rider 102 may use the motorized handle as an aid to steering or balance, in addition to providing motive force for propulsion. By way of example, motive force of wheel 114 against the ground 124 is transmitted through rider 122 to the skateboard 104.

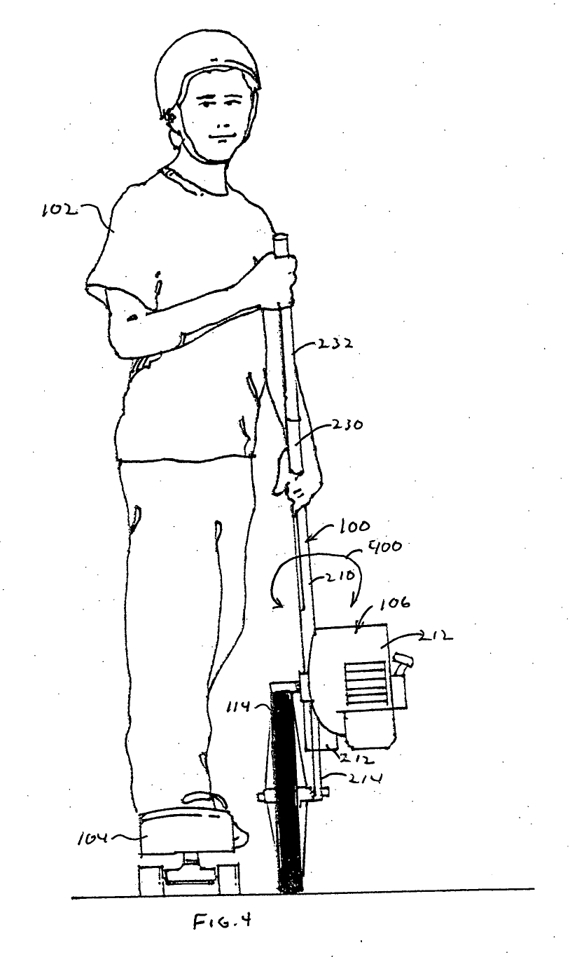

As shown in FIG. 4, the rider 102 may alter his body position while using the motorized handle 100. The motorized handle may, for example, be twisted on arc 400 so that propulsion from wheel 114 is off-axis from the direction of skateboard 104. This twisting may be accompanied by the rider 102 leaning towards motorized handle 100 so as to place weight on the motorized handle 100 and turn the skateboard 104 for a left turn or to lean away to remove weight from motorized handle 100 for a right turn. The rider 102 may reposition the wheel away from the skateboard 104, closer to the skateboard 104, or to a location that is relatively forward or rearward of the position indicated in FIG. 4. The rider 104 may crouch or stand taller than the position shown in FIG. 4. These variations are provided to show that the motorized handle 100 may be repositioned to an infinite number of locations as may suit the desires of rider 102 and that the motorized handle 100 may receive different amounts of weight at different points in time to facilitate propulsion according to the rider's desire.

Those skilled in the art will appreciate that the foregoing description teaches by way of example and not by limitation. The disclosed embodiments may be subjected to insubstantial changes that fall within the scope and spirit of the invention. As to these changes, the inventor hereby states his intention to rely upon the Doctrine of Equivalents to protect the scope and spirit of the invention.

I claim:

1. A motorized handle comprising:
an elongate handle presenting an upper end and a lower end;
a wheel attached to the handle proximate to the lower end;
a motor attached to the handle proximate the wheel; and
a drive mechanism extending between the motor and the wheel, the drive mechanism configured to impart motive force to the wheel.

2. The motorized handle of claim 1, wherein the motor is an air cooled gasoline engine equipped with a centrifugal clutch.

3. The motorized handle of claim 2, wherein the centrifugal clutch drives a shaft that resides in frictional contact with the wheel.

4. The motorized handle of claim 3 including a clamp assembly for use in adjusting the strength of the frictional contact.

5. The motorized handle of claim 1, wherein the handle is an extensible handle formed in at least two telescoping segments.

6. A method for a rider to propel a rolled conveyance, comprising:
mounting the rolled conveyance;
gripping an elongate handle that is provided with a motor operably configured to drive a wheel with motive force;
placing the wheel on the ground to there impart the motive force against the ground; and
using the motive force to propel the rolled conveyance by transmitting the motive force to the rolled conveyance through the body of the rider.

7. The method of claim 6, wherein the step of using entails using the motive force as an aid to steering the rolled conveyance.

8. The method of claim 6, wherein the step of using entails using the motive force as an aid to the rider's balance.

9. The method of claim 6, wherein the rolled conveyance used in the step of mounting includes a skateboard.

10. The method of claim 6, wherein the rolled conveyance used in the step of mounting includes a pair of roller skates or roller blades.

11. The method of claim 6, wherein the rolled conveyance used in the step of mounting includes a wheelchair.
